(19) United States
(12) Patent Application Publication
(10) Pub. No.: US 2005/0021643 A1
(43) Pub. Date: Jan. 27, 2005

(54) Electronic mail system, terminal device and software

(75) Inventors: Muneaki Watanabe, Higashiyamato (JP); Yoshikuni Mae, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/854,077

(22) Filed: May 24, 2004

(30) Foreign Application Priority Data
May 30, 2003 (JP) 2003-153709

(51) Int. Cl. H04M 1/64

(52) U.S. Cl. 709/206; 709/205

(57) ABSTRACT

When a mail is shared, it is necessary to store data of the mail to be shared in a storage device on a server. Recently, however, an attachment file having large capacity like image data has been increasingly used, and a method for storing mail data in a storage device of a server involves a problem of large capacity loads. To solve such problem, an electronic mail system which sends and receives an e-mail between a first terminal device and a second terminal device transmits to the second terminal device link information about a shared mail which is an e-mail designated to be shared out of e-mails stored in the above-stated first terminal device, and if transmission of the shared mail is requested by using the link information from the second terminal device, the first terminal device transmits the shared mail to the second terminal device.

### CLAIMS OF PRIORITY

The present application claims prority from Japanese application serial no. 2000-153709, filed on May, 30, 2004, the content of which is hereby incorporated by reference into this application.

### BACKGROUND OF THE INVENTION

1. Field of the Invention

The present invention relates to a method for sharing a mail of an electronic mail system.

2. Description of the Prior Art

With a prior art, mail sharing that allows another user to refer to mails is realized, by storing data of all mails to be shared, among mails that were received by certain users, on a server which is accessible from terminal devices within a group (for example, Japanese Patent Laid-open No. 2001-36568).

### SUMMARY OF THE INVENTION

Multi-media data has prevailed in recent days and hard disks, etc. which are typical storage devices for personal computers (hereinafter referred to as “PCs”) have been increased in storage capacity and been inexpensive rapidly. Along with such trends, storage devices for servers are also becoming larger in storage capacity, but, actually, an additional capacity of a server cannot be provided due to insufficient capacity since an administrator periodically backs up data in view of potential failures or troubles. To that end, for a storage device capacity of a server usually, a certain size is usually allocated for each group and the server is operated within the range that does not exceeds the allocated capacity. If the capacity allocated to the storage device of the server is running short, each group deals with the problem by erasing unnecessary or old data, etc.

In addition, when data to be sent and received via an e-mail is configured only with conventional character codes, the capacity of mail data will not be so large. Accordingly, even if the mail data to be shared is stored on the server, the storage device of the server had a small load of capacity and it was conventionally possible to freely share mail data. However, prevailing of multi-media as described above allowed data to be sent and received via an e-mail to contain larger capacity of data such as images, video images and voices than text data of character codes or the like. For example, capacity of most mail documents containing a typical image reaches about 1 megabytes, and this means the size is equivalent to 500,000 characters. Supposing a typical mail contains about 1,000 characters, the capacity of a document mail containing an image will reach 500 times the capacity of a typical mail. Under such circumstances, mail data capacity is becoming significantly sizable, and larger capacity is being demanded for storage devices in which mail data is stored.

However, with the prior art described above, there was a problem that a server is subjected to larger loads in terms of storage capacity of a storage device in the server, since it is necessary to store mail data of a shared mail on a server. For example, there may be a possibility that many mails cannot be shared due to restrictions in terms of storage capacity of the storage device of the server.

An object of the present invention is to solve the above-described problems and enable sharing of many mails while reducing loads on the server.

To solve the above-described problems, there is provided an electronic mail system according to the present invention, wherein the electronic mail system which sends and receives an e-mail between a first terminal device and a second terminal device transmits to the second terminal device link information about a shared mail which is an e-mail designated to be shared out of e-mails stored in the above-stated first terminal device, and if transmission of the shared mail is requested by using the link information from the second terminal device, the first terminal device transmits the shared mail to the second terminal device.

By employing such configuration, it is possible to share many e-mails while reducing capacity load on the storage device of the server since e-mails to be shared are directly transmitted to the second terminal device from the first terminal device without storing such e-mails in the server.

Therefore, according to the present invention, it is possible to reduce loads on the server.

### BRIEF DESCRIPTION OF THE DRAWINGS

FIG. 1 is an example of a configuration provided to implement a first embodiment;

FIG. 2 is a shared flag management table of the first embodiment;

FIG. 3 is a table of shared mail links of the first embodiment;

FIG. 4 is a group management table of the first embodiment;

FIG. 5 is a flow chart showing a shared mail designation flow of the first embodiment;

FIG. 6 is a flow chart showing an acquisition of shared mail of the first embodiment;

FIG. 7 is an example of a shared mail designation window of the first embodiment;

FIG. 8 is an example of a shared mail acquisition designation window of the first embodiment;

FIG. 9 is an example of a configuration provided to implement a second embodiment;

FIG. 10 is a group management table of the second embodiment;

FIG. 11 is a shared flag management table of the second embodiment;

FIG. 12 is a flow chart showing a shared mail designation flow of the second embodiment;

FIG. 13 is a flow chart showing an acquisition of shared mail of the second embodiment;

FIG. 14 is an example of a shared mail designation window of the second embodiment; and

FIG. 15 is an example of a shared mail acquisition designation window of the first embodiment.

### DESCRIPTION OF THE PREFERRED EMBODIMENTS

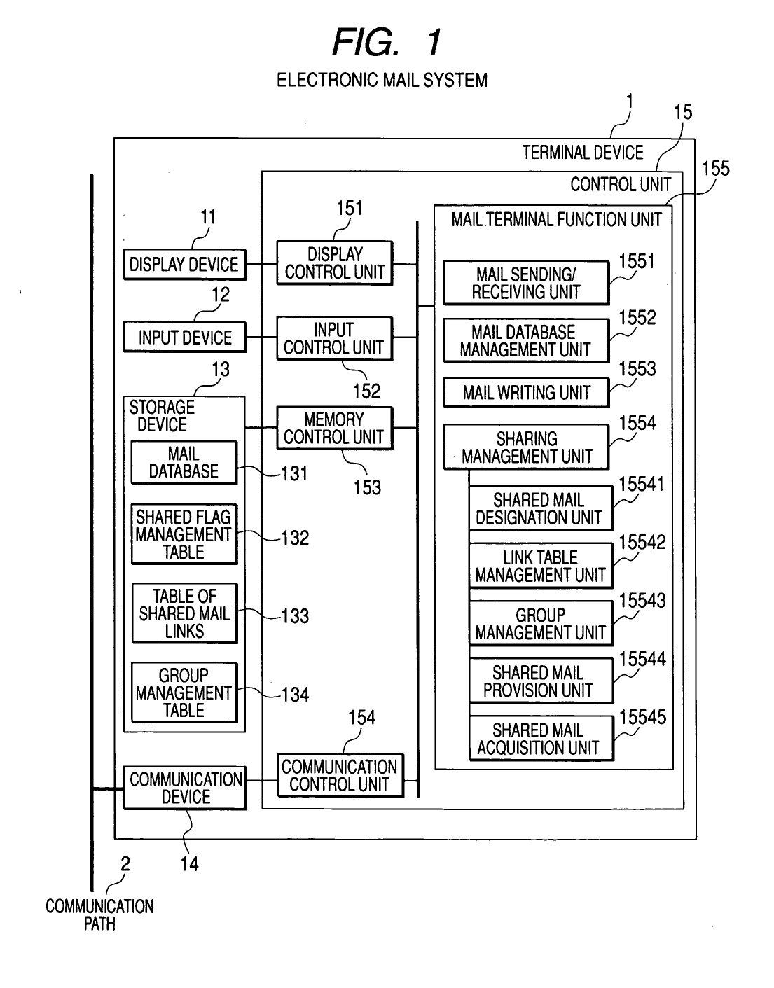

Hereinafter, a first embodiment of an electronic mail system according to the present invention will be described with reference to the accompanying drawings FIG. 1 to FIG. 8.

FIG. 1 is a diagram showing a configuration of a terminal device of the electronic mail system to which the first embodiment is applied. The reference numeral 1 is a terminal device. Actually, the terminal device 1 is configured with a plurality of units and is further connected, via a communication path 2, to a mail server which sends and receives mails. However, in the embodiment, FIG. 1 shows only one terminal device 1 and the communication path 2, and other terminal devices and the mail server are omitted.

The reference numeral 11 is a display device, or more specifically a liquid crystal display, etc., to display characters, graphics, images, etc. as instructed by various kinds of application software. The reference numeral 12 is an input device, or more specifically a keyboard which comes with the terminal device 1, to accept entries from a user.

The reference numeral 13 is a storage device, or more specifically a device which features a random access memory (RAM), a hard disk, a flush memory, etc., to store various kinds of application software of the terminal device 1, various files that are created by the software, and a work area that is used by a program when the program is executed. The storage device 13 includes a mail database 131, a shared flag management table 132, a table of shared mail links 133, and a group management table 134. The mail database 131 is for a user who uses the terminal device 1. The shared flag management table 132 is used to identify a mail shared with other terminal devices 1, which will be described later. The table of shared mail links 133 stores information necessary when mails shared with other terminal devices are acquired and stored. A group management table 134 stores terminal device information which is used to identify a terminal device with which a mail can be shared.

The reference numeral 14 is a communication device, or more specifically, a network card or a device such as a modem, to allow the terminal device 1 to communicate with other servers or other terminal devices via a local area network (hereinafter referred to as a “LAN”), a telephone line, etc.

The reference numeral 15 is a control unit which represents various control units of the terminal device 1 to control various devices stated above, a function unit of the terminal device 1 to control sending, receiving and sharing of a mail, etc. The control unit 15 in included the terminal device 1 will be described hereinafter.

The reference numeral 151 is a display control unit. This control unit controls displaying of sensible information consisting of characters, images or the like on the display device 11, according to an instruction made by applications in the terminal device 1. The reference numeral 152 is an input control unit to notify input information, etc. that are entered from the input device 12 to respective control units or application software. The reference numeral 153 is a memory control unit to write and read data to and from the storage device 13 according to a request for reading and writing of user data from various control units or various kinds of application software. Data included in the user mail database 131 of the terminal device 1, shared flag management table 132 in the present embodiment, table of shared mail links 133, and group management table 134 are stored in the storage device 13 via the memory control unit 153. The reference numeral 154 is a communication control unit to control the communication device 14 when the terminal device 1 communicates with a server such as a mail server or other terminal devices, etc.

The reference numeral 155 is a mail terminal function unit to realize the terminal device 1 according to the embodiment and is configured with a mail sending/receiving unit 1551, a mail database management unit 1552, a mail writing unit 1553, and a sharing management unit 1554. The mail sending/receiving unit 1551 executes a process to store user mail data stored in mail box of the mail server connected to the communication path 2 in an “inbox” folder available in the mail database 131 of the terminal device 1. Further, the mail sending/receiving unit 1551 executes transmission of a mail stored in the “outbox” folder available in the mail database 131 according to an instruction by a user to other users. The mail database management unit 1552 manages mails that were sent or received by the mail sending/receiving unit 1551 in the storage device 13. Specifically, the unit 1552 provides functions to store mails sent or received by a user in the mail database 131, display the mails hierarchically for a more easily understandable manner as well as contents of body texts of the mails, etc., sort out the mails by subjects and delete unnecessary mails. The mail writing unit 1553 provides a function to create a mail to be transmitted. A mail created is stored in the “sent items” folder available in the mail database 131 after being processed by the mail database management unit 1552, and is then transmitted via the communication path 2 according to a mail transmission instruction from the mail sending/receiving unit 1551.

The sharing management unit 1554 is a processing unit to realize the terminal device 1 of the embodiment and includes a shared mail designation unit 15541, a link table management unit 15542, a group management unit 15543, a shared mail provision unit 15544, and a shared mail acquisition unit 15545. The shared mail designation unit 15541 executes a process to make a user to designate a mail to be shared among mails in the mail database 131. The shared mail designation unit 15541 also executes processes to register link information of the mail thus designated on a mail ID, a terminal address, etc. with the table of shared mail link 133, notify the link information to a terminal device which is registered in the group management table 134, and further store information on the shared mail designated in the shared flag management table 132. It should be noted that data to be transmitted shall be of a format of the storage information available in the table of shared mail link 133. The link table management unit 15542, upon receiving the link information on the shared mail transmitted from the shared mail designation unit 15541 of another terminal device, adds the link information to the table of shared mail link 133. In addition, if the link table management unit 15542 receives a request for acquiring the link information of the above-stated shared mail, the link table management unit 15542 receives the request, and executes processes of reading associating link information from the table of shared mail link 133 and transmitting the link information on mail sharing to the request source terminal device. Further, the link table management unit 15542 executes a process to display information that has been additionally registered with the table of shared mail link 133.

Here, with the timing when the off-line status where the terminal device 1 is disconnected from the communication path 2 has shifted to the on-line status where the terminal device 1 is coupled to the communication path 2, the link table management unit 15542 executes processes to request the link information on the shared mail to each terminal device registered with the group management table 134 and register the link information on the shared mail thus acquired with the table of shared mail link 133.

The group management unit 15543 executes processes to make a user designate a group which is to share a mail, and to create and modify the group management table 134. The shared mail provision unit 15544, upon receiving an information acquisition request for shared mail data from another terminal device, transmits the designated mail data available in the mail database 131 that is stored in the storage device 13 to the request source terminal device for the acquisition. The shared mail acquisition unit 15545, upon designation of a desired mail on the display window based on information of the table of shared mail links 133 when the terminal device 1 acquires a mail shared with another terminal device, executes processes of acquiring, according to the table of shared mail links 133 and the group management table 134, the mail from the mail database 131 of a terminal device in which the designated mail is stored and displaying the mail thus acquired.

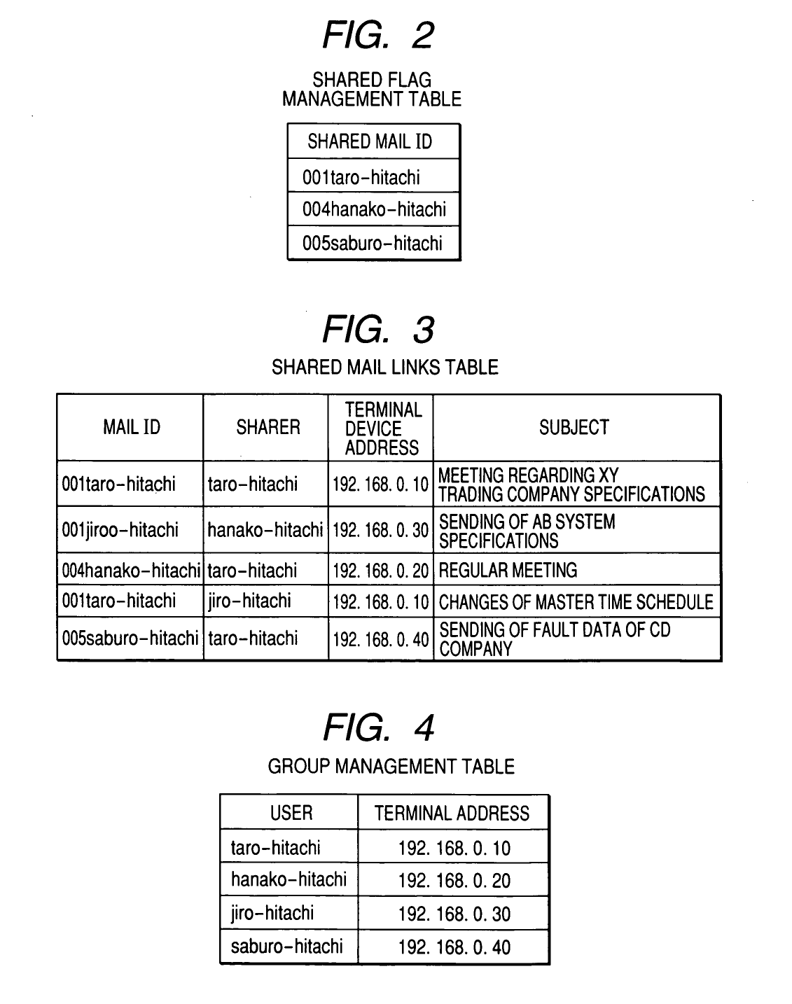

FIG. 2 shows contents of the shared flag management table, and the table stores information that should be retrieval key indices of shared mails stored in the mail database 131. In the embodiment, it is arranged that mail IDs are held for uniquely discriminating mails at the time of transmitting mails.

FIG. 3 shows contents of the table of shared mail links 133, and the table stores link destinations showing locations of mails shared. In the embodiment, it is arranged that mail IDs that are retrieval keys to identify shared mails in the mail database 131 of each terminal device, names of users sharing the mails, addresses of terminal devices shared, and subjects of mails are stored. It should be noted, however, that since addresses shared by terminal devices are also designated in the group management table 134 to be described later, the addresses may be omitted here as the case may be. Further, it may also be arranged that, in addition to the information described above, capacity of mails shared, availability of attachment files, etc. can be stored as required.

FIG. 4 shows contents of the group management table 134, and the table is used to discriminate, when transmitting link information of shared mails to be shared, to which terminal device the transmission should be made. In the embodiment, it is arranged that names of users who can share the mails and addresses of terminal devices used by the users are stored.

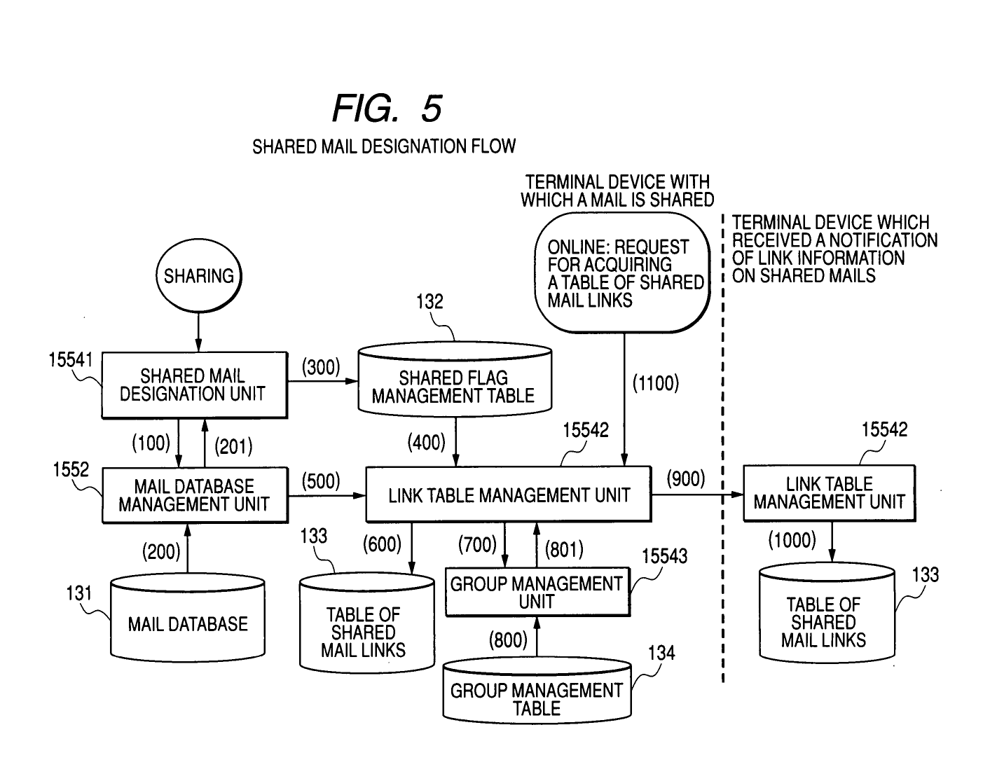

Next, a process flow for sharing a mail according to the embodiment will be described with reference to FIG. 5.

First, when a user designates an arbitrary mail as should be shared, the shared mail designation unit 15541 acquires information on subject, date, size, and mail ID which uniquely determines the mail, of the mail stored in the mail database 131 (200, 201) via the mail database management unit 1552 (100), and displays a selection window to designate the mail to be shared. Here, when the user designates an arbitrary mail on the selection window as a shared mail, the shared mail designation unit 15541 stores the mail ID of the designated mail in the shared flag management table 132 (300). Next, the link table management unit 15542 obtains information on the subject, etc. of the mail having the appropriate mail ID from the mail database management unit 1552 (500) based on mail IDs stored in the shared flag management table 132 (400). The link table management unit 15542 then stores the mail ID, a sharer (the principal sharer, in this case), the address of the terminal device shared (a terminal device used by the user, in this case), and the mail subject in the table of shared mail links 133 (600). Concurrently, the link table management unit 15542 obtains address information of another terminal device with which the mail is shared from the group management table 134 (800, 801), and transmits information on the shared mail registered with the table of shared mail links 133 to all terminal devices registered (900).

It should be noted that the information to be transmitted here shall be storage information registered with the table of shared mail links 133. The information transmitted is received by the link table management unit 15542 of another terminal device, and the information received is additionally registered with the table of shared mail links 133 of the terminal device (1000). Thereafter, a process to display the shared mail is executed based on the information of the table of shared mail links 133.

With the arrangement stated above, it is possible to put an arbitrary mail in the shared status on the terminal device 1, thus enabling to refer to information on a mail that is put in the shared status by another terminal device.

Note that, with the embodiment, the table of shared mail links 133 is re-configured with the timing when the terminal device 1 is shifted from the off-line status that the unit is disconnected from a network to the on-line status that the unit is re-connected to the network. At this time, it is necessary to provide link information of the shared mail to another terminal device, and the flow is as follows. The on-line status information is first received by the link table management unit 15542 (1100), all mail IDs that are registered with the shared flag management table 132 are acquired (300), and thereafter, the flow following the step (400) stated above is executed.

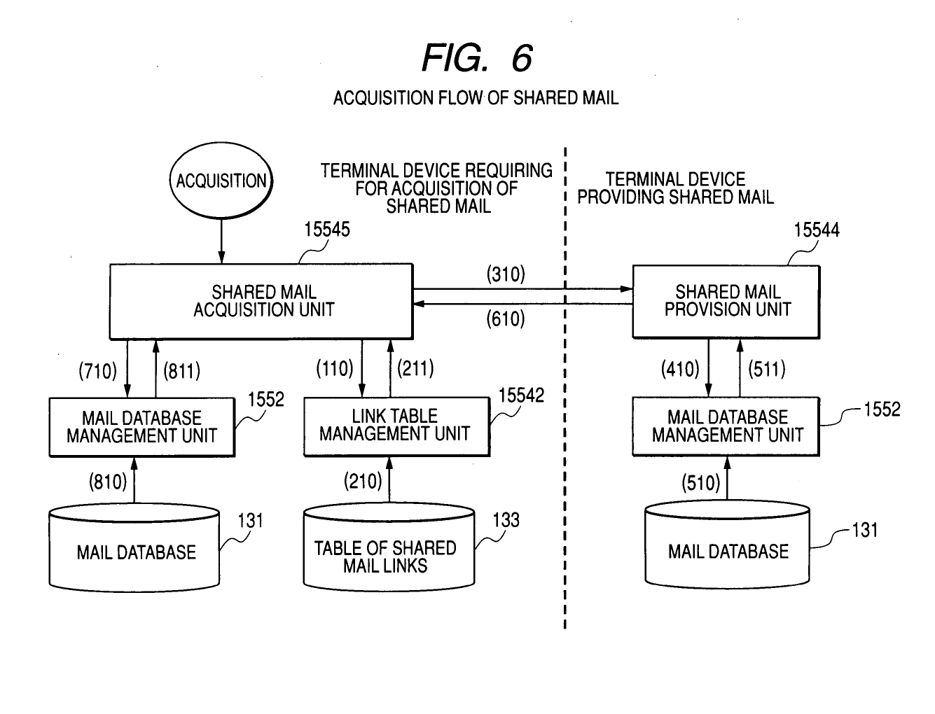

Next, a flow of processes to acquire and refer to the contents of a shared mail according to the embodiment will be described with reference to FIG. 6.

To begin with, when a user acquires a desired shared mail, the shared mail acquisition unit 15545 acquires link information on shared mails stored in the shared mail link table 133 (200, 201) via the link table management unit 15542 (110) and displays a selection window on which the shared mail is selected. Here, if the user designates a mail to acquire a desired arbitrary shared mail on the selection window, the shared mail acquisition unit 15545 transmits a mail acquisition request to a terminal device which registers the desired designated mail as a shared mail (310). The request is received by the shared mail provision unit 15544 of a terminal device providing shared mail, the mail data thus requested is acquired (510, 511) via the mail database management unit 1552 (410), and the mail data is provided to a terminal device requiring for acquisition of shared mail (610). The terminal device requiring for acquisition of shared mail receives the mail data and stores the mail data in the mail database 131 (810) via the mail database management unit 1552 (710), thus making the mail data acquisition of the shared mail possible. Further, the mail database management unit 1552 displays the contents of the mail thus acquired.

Meanwhile, it should be noted the reason why the mail acquired is stored in the mail database 131 is to eliminate the necessity to re-acquire an already acquired mail when required again. The mail acquired may not be stored, or the mail may be acquired again as required.

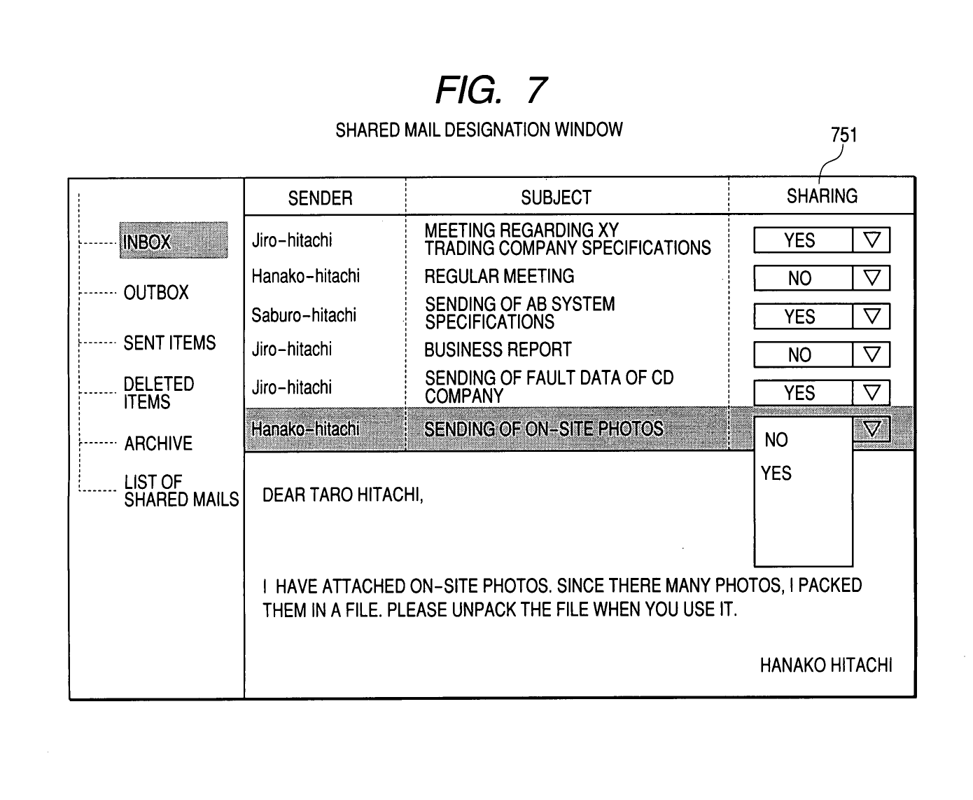

FIG. 7 is an example of a window to designate a mail to be shared wherein the embodiment is applied. At the right-hand side of the window, a field to designate “sharing” 751 is provided for each mail, and a user chooses “Yes” for a mail to be shared, while “No” for a mail not to be shared. When “Yes” is chosen, the process described in FIG. 5 stated above will be executed.

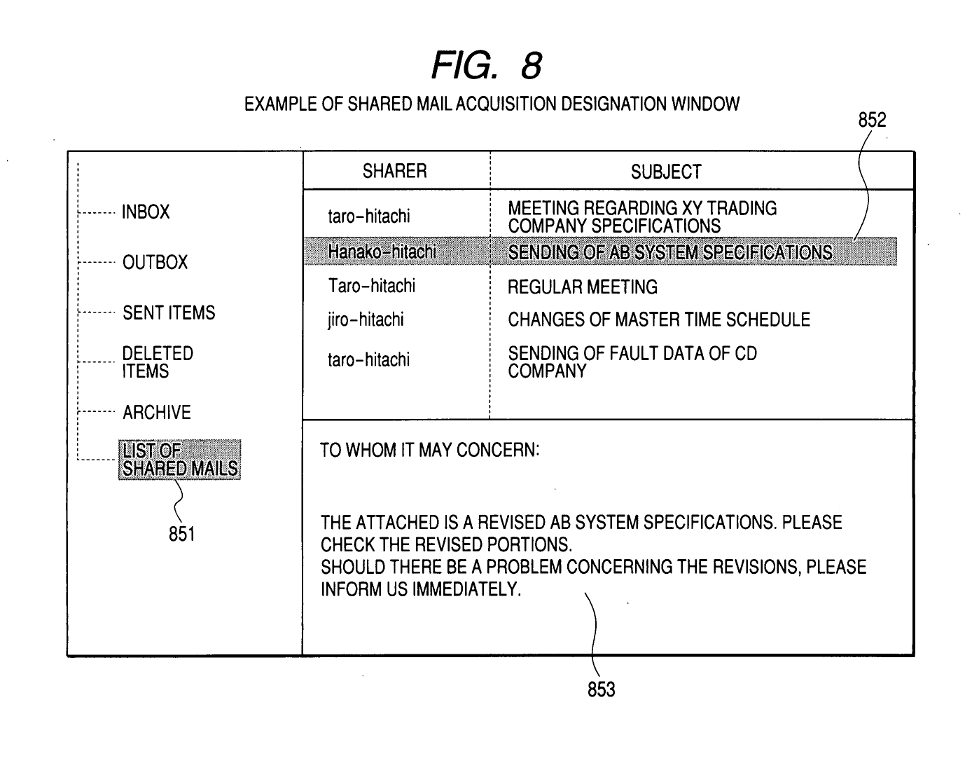

FIG. 8 is an example of a window to acquire a mail that is designated to be shared wherein the embodiment is applied. When the item “List of shared mails” 851 located at the lower left of the window is chosen, a list of mails which are currently shared by terminal devices that are registered with the table of shared mail link 133 is displayed. Here, when a mail 852 to be referred to is chosen, the process described in FIG. 6 stated above will be executed, and the acquired mail is displayed in the pane 853 located at the lower right of the window.

With the configuration as stated above, it is possible to eliminate a storage device for shared mail data in the server and realize mail sharing only among terminal devices.

With the first embodiment stated above, since a terminal device directly receives an e-mail from another terminal device and does not store data of the e-mail in the server, it is possible to share many mails while reducing load of storage capacity of the server.

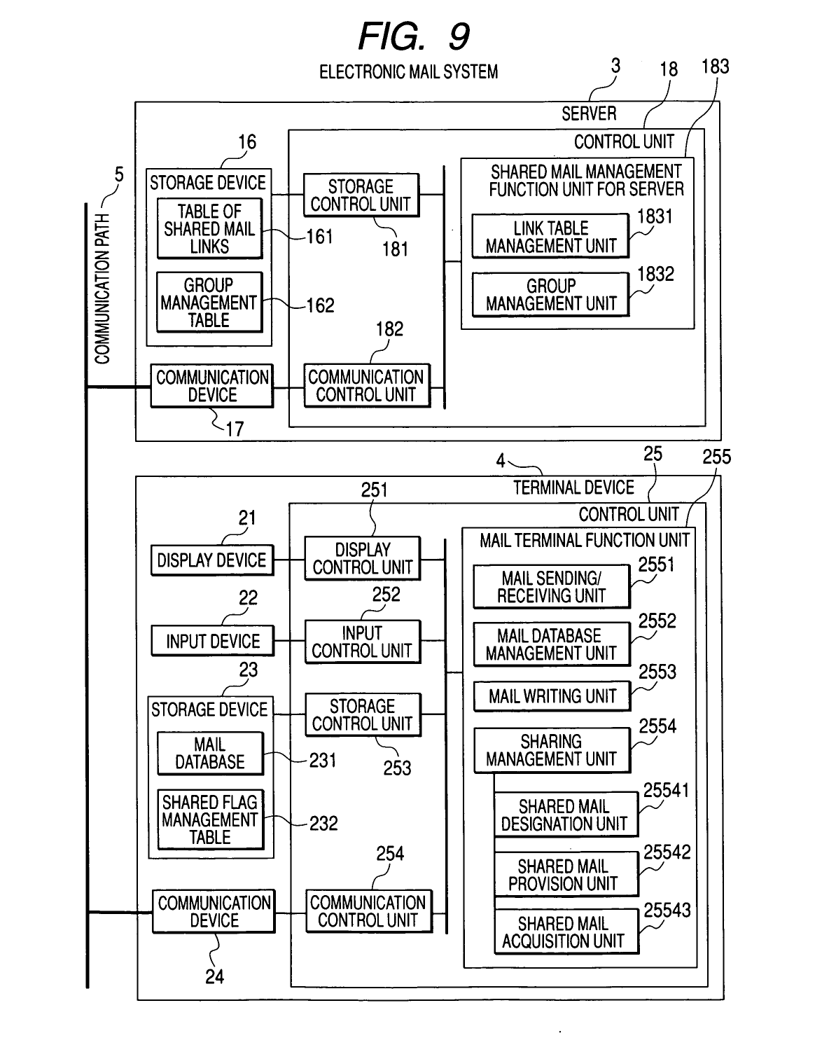

Next, a second embodiment of an electronic mail system according to the present invention will be described with reference to FIGS. 9 to 15.

FIG. 9 is a configuration diagram showing an electronic mail system wherein the second embodiment is applied. The reference numeral 3 is a server and the reference numeral 4 is a terminal device, and the server 3 and the terminal device 4 are coupled via a communication path 5. It should be noted that, for implementation of the embodiment, a plurality of terminal devices 4 actually exist in connection with the server 3. Further, in some cases, a mail server to send and receive a mail exists in addition to the server 3, and the mail server is also coupled to the server 3. However, such plurality of terminal devices and the mail server are omitted in FIG. 9. Here, the server 3 may be integrated with the mail server. Hereinafter, parts of the server 3 will be described in detail.

The reference numeral 16 is a storage device, or more specifically, a device which uses a RAM, a hard disk, a flush memory or the like, and the device stores various kinds of application software, various files created by such software, and a work area to be used by programs when the programs are executed. It should be noted that a table of shared mail links 161 which stores information necessary for acquiring a mail that is designated to be “shared” by a terminal device 4 as described later, and a group management table 162 which stores terminal information to identify a terminal device which can share the mail are also stored in the storage device 16.

The reference numeral 17 is a communication device, or specifically, a network card or a device such as a modem, to allow the server 3 to communicate with other servers or other terminal devices via a local area network (hereinafter referred to as a “LAN”), a telephone line, etc. Note that some servers have a display device or an input device, but, with the server 3 of the embodiment, such display device or input device is omitted.

The reference numeral 18 is a control unit which represents various control units to control various devices of the server 3 stated above, and a function unit to control various kinds of application software, etc. and sharing of a mail, etc. Hereinafter, the control unit 18 of the server 3 will be described in detail.

The reference numeral 181 is a storage control unit to control data writing and reading to and from the storage device 16 upon having a request for reading and writing of user data from various control units or various kinds of application software. It should be noted that data of a table of shared mail links 161 and a group management table 162 of the embodiment are also accessible via the storage control unit 181. The reference numeral 182 is a communication control unit to control the communication device 17 which enables the server 3 to communicate with the terminal device 4, other servers, etc. via the communication path 5.

The reference numeral 183 is a shared mail management function unit for server which implements the second embodiment. The shared mail management function unit includes a link table management unit 1831 and a group management unit 1832. The link table management unit 1831 is a function to manage the table of shared mail links 161 which is stored in the storage device 16 of the server 3. The unit 1831 receives mail sharing information which is available when the terminal device 4 designates a mail to be shared, and executes a process to store the information in the table of shared mail links 161. When the terminal device 4 sends a request for acquiring link information of the table of shared mail links 161 to acquire mails which are designated to be shared by other terminal devices, the unit 1831 executes a process to transmit the appropriate link information of the table of shared mail links 161 to the request-source terminal device. The group management unit 1832 executes access control processes, when the terminal device 4 designated the mail to be shared, as to which user the access permission to refer to the mail should be given, and, when the user is going to acquire the mail which is designated by other terminal devices via the terminal device 4, as to whether the user requesting for the acquisition has a right to access the mail designated to be shared.

It should be noted that, with the embodiment, the group management unit 1832 is arranged in the manner that an administrator of the server 3 registers user groups which have the same access permission in advance to manage the access permissions to shared mails, but, it shall be also arranged that the group management table 162 can be created, corrected, altered, etc. by the groups.

Next, the terminal device 4 will be described in detail. The reference numeral 21 is a display device, or more specifically, a liquid crystal display, etc., to display characters, graphics, images or the like according to instructions by various kinds of application software. The reference numeral 22 is an input device, or more specifically, a keyboard which comes with the terminal device 4, to accept entries from a user.

The reference numeral 23 is a storage device, or more specifically a device which uses a random access memory (RAM), a hard disk, a flush memory, etc., to store various kinds of application software, various files that are created by the software, and a work area that is used by a program when the program is executed. It should be noted that a mail database 231 of a user who uses the terminal device 4, a shared flag management table 232, to be described later, which is used to identify a mail shared in the terminal device 4 are also stored in the storage device 23.

The reference numeral 24 is a communication device, or more specifically, a network card or a device such as a modem, to allow the terminal device 4 to communicate with the server 3 or other terminal devices via a LAN, a telephone line, etc.

The reference numeral 25 is a control unit which represents various control units of the terminal device 4 to control various devices stated above, and a function unit to realize sending/receiving of mail, sharing processes and other functions. Hereinafter, the control unit 25 of the terminal device 4 will be described.

The reference numeral 251 is a display control unit to control displaying of sensible information consisting of characters, images or the like on the display device 21 according to instructions of various kinds of application software in the terminal device 4. The reference numeral 252 is an input control unit to transmit input information, etc. that are entered from the input device 22 to respective control units or application software. The reference numeral 253 is a memory control unit to write and read data to and from the storage device 23 according to a request for reading and writing of user data from various control units or various kinds of application software. It should be noted that a mail database 231 of a user who uses the terminal device 4, and a shared flag management table 232 of the embodiment are also stored in the storage device 23. The reference numeral 254 is a communication control unit to control the communication device 24 when the terminal device 4 communicates with the server 1 or other terminal devices, etc.

The reference numeral 255 is a mail terminal function unit to implement the terminal device 4 according to the embodiment. This unit includes a mail sending/receiving unit 2551, a mail database management unit 2552, a mail writing unit 2553, and a sharing management unit 2554. The mail sending/receiving unit 2551 executes a process to store user mail data stored in a mailbox of the mail server connected to the communication path 5 in the “inbox” folder in the mail database 231 of the terminal device 4. The mail sending/receiving unit 2551 also executes transmission of a mail stored in the “outbox” folder available in the mail database 231 according to the user's instruction. The mail database management unit 2552 manages mails that are sent or received by the mail sending/receiving unit 2551 in the storage device 23. The unit 2552 provides functions to store mails sent or received by a user in the mail database 231, display the mails hierarchically for a more easily understandable manner as well as contents of body texts of the mails, etc., sort out the mails by subjects, and delete unnecessary mails. The mail writing unit 2553 provides a function to create a mail to be transmitted. A mail created is stored in the “outbox” folder available in the mail database 231 after being processed by the mail database management unit 2552, and is then transmitted via the communication path 5 according to a mail transmission instruction from the mail sending/receiving unit 2551.

The sharing management unit 2554 is a processing unit to implement the terminal device 4 of the embodiment. This unit includes a shared mail designation unit 25541, a shared mail provision unit 25542 and a shared mail acquisition unit 15543. The shared mail designation unit 25541 executes a process to make a user designate a mail to be shared among mails in the mail database 231. The shared mail designation unit 25541 also executes a process to make a user designate a sharing group, etc. to which an access permission obtained from a group management unit 1832 of the server 3 is to be given. The shared mail designation unit 25541 further executes a process to transmit link information such as a mail ID of the designated mail and a terminal address to the server 3 to reflect such information on the table of shared mail links in the server 3, and a process to store such information in the shared flag management table 232 in the terminal device 4. The shared mail acquisition unit 25543, when the terminal device 4 acquires a mail that is shared with another terminal device, executes processes to acquire data of the table of shared mail links 161 of the server 3, and when a user designates a mail to be acquired, access the terminal device which shares the designated mail data based on the table of shared mail links 161 and the group management table 162 of the server 3, acquire the mail data from the mail database 231, and display the mail thus acquired.

It should be noted that, with the embodiment, the table of shared mail links 161 shall be of the same configuration as that of the first embodiment as described in FIG. 3, and that the table of shared mail links 161 shall store a mail ID which is a retrieval key to identify a shared mail in the mail database 131 of each terminal device, a shared user name, an address of terminal device shared, and a subject of the mail. It should also be noted that, in addition to such information, capacity of shared mail, availability of an attached file, etc. shall be able to be added as required.

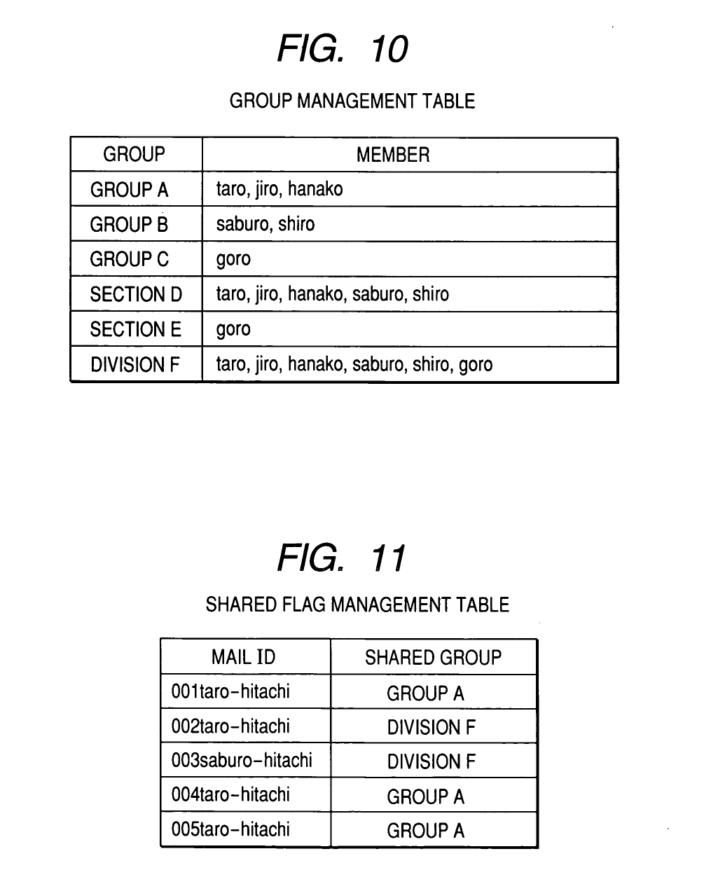

FIG. 10 shows an example of the group management table 162, and, with the embodiment, the table is configured to show users by belonging groups to be shared. In the example, a mail shared with designation “Group A” can be shared among taro, jiro and hanako, and the “Group B” shows that a mail can be shared between saburo and shiro. In addition, since “Group D” is arranged to be a section which is made by combining “Group A” and “Group B”, the members who can share the mail are taro, jiro, hanako, saburo and shiro.

FIG. 11 is an example of the shared flag management table 232, and the table is configured to store groups that are declared with mail IDs and group management tables.

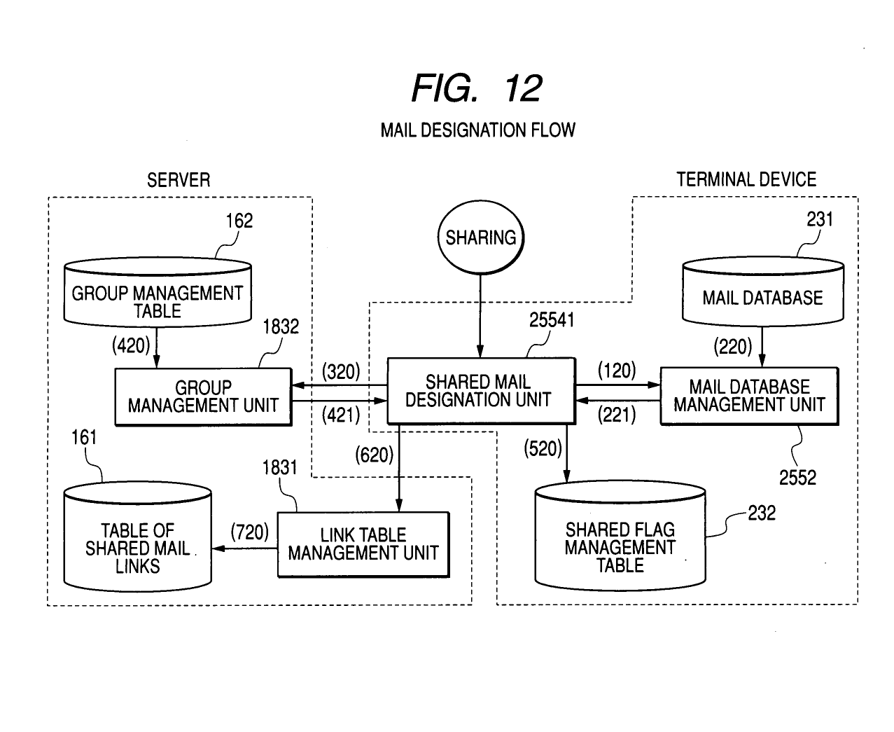

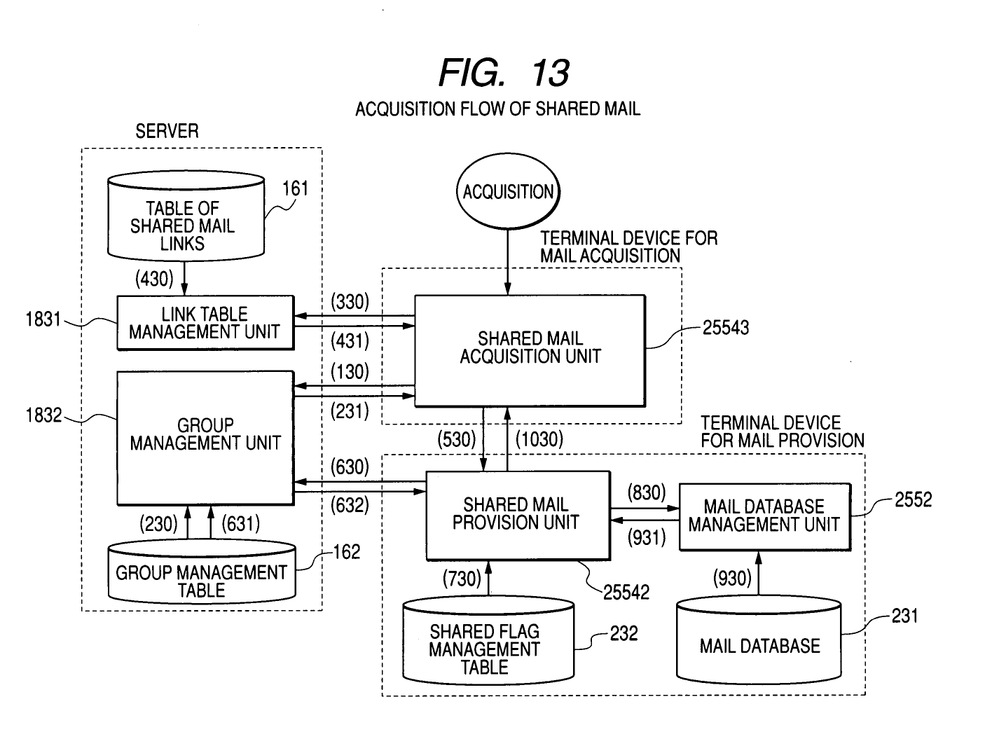

Next, the process flow will be described. FIGS. 12 and 13 are diagrams showing process flows for sharing a mail, and acquiring and referring the shared mail. First, a process flow when the terminal device 4 shares a mail according to an instruction by a user will be described hereunder.

First, when a user operating the terminal device 4 shares a mail which is stored in the user's mail database 231 with another user, the shared mail designation unit 25541 extracts a mail list including information such as subject, date, and size of a mail which is downloaded to the terminal device 4 (220, 221) via the mail database management unit 2552 (120). Further, the shared mail designation unit 25541 sends a query to the group management unit 1832 (320), obtains a list of shared group which can be shared by the user (420, 421) from the group management unit 1832, and displays a mail list window on which the user will designate a mail to be shared. Here, if the user designates a mail to be shared out of the mail list, the shared mail designation unit 25541 newly adds a mail ID for the designated mail in the shared flag management table 232 (520), and further, transmits the mail ID of the selected mail, the shared user, the address of the sharing mail terminal device, the mail subject, etc. to the link table management unit 1831 of the server 3 (620). The link table management unit 1831, upon receiving such information, stores the information received in the table of shared mail links 161 (720). Thereafter, the link table management unit 1831, upon receiving a request for displaying the shared mail from the terminal device 4, executes a process to display the list of shared mails based on the information of the table of shared mail links 161.

With the arrangement described above, it is possible to put an arbitrary mail in the shared status on the terminal device 4, thus enabling to make reference to the list of mails which are designated to be shared by another terminal device.

Next, referring to FIG. 13, process flows for referring to a list of shared mails that are designated to be shared, and also for acquiring and referring to data of a mail will be described.

When a user acquires a shared mail which is shared among other users, to acquire a list of mails that are currently in shared status, the following steps will be taken. First, the shared mail acquisition unit 25543 of a terminal device for mail acquisition obtains a list of shared groups which can be shared by users from the group management table 162 (230, 231) via the group management unit 1832 of the server 3 (130), discriminates a group to which a user from whom the shared mail is to be acquired belongs, and acquires a table of shared mail links 161 of the group to which the user belongs to (430, 431) via the link table management unit 1831 (330). It should be noted that, with the embodiment, although it is configured that all information of the table of shared mail links 161 are acquired, it shall also be possible to obtain only difference from previous acquisition, thus reducing network loads. When information on the list of shared mails based on information obtained from the table of shared mail links 161 is displayed and the user designates a mail to be acquired, the shared mail acquisition unit 25543 investigates, from the table of shared mail links 161, the address of a terminal device in which the designated mail is stored (hereinafter referred to as the “terminal device for mail provision”), and sends a mail acquisition request to the terminal device for mail provision (530). The shared mail provision unit 25542 of the terminal device for mail provision, upon receiving the request, obtains a list of shared groups that can be shared by the users from the group management table 162 (631, 632) via the group management unit 183 of the server 3 (630), and confirms whether the user of the request-source terminal device for mail provision has an access permission. If the access permission is given, the shared mail provision unit 25542 confirms whether the requested mail is currently designated to be a shared mail by the unit's own terminal device for mail provision based on the information of the shared flag management table 232 (730). If the mail is designated to be a shared mail, the shared mail provision unit 25542 acquires the designated mail (930, 931) via the mail database management unit 2552, and transmits the requested mail data to the request-source terminal device for mail provision (1030), thus enabling acquisition of mail data of the shared mail. Further, the terminal device for mail provision displays contents of the mail acquired by the mail database management unit 2552.

With the above-described arrangement, it is possible to acquire and refer to the mail which is designated to be a shared mail.

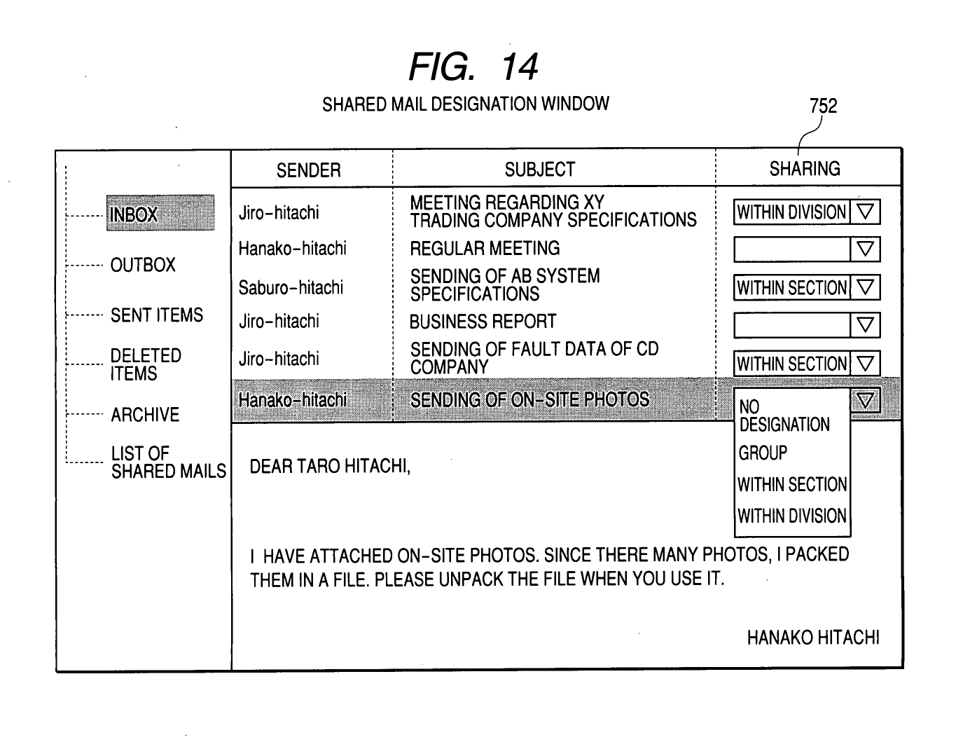

FIG. 14 is an example of a window to designate a mail to be shared wherein the embodiment is applied. At the right-hand side of the window, a field to designate “sharing” 752 is provided for each mail, and a user chooses “∇” for a mail to be shared, and chooses a desired shared group (for example, within division) out of pulldown options to be displayed, or chooses “no designation” for a mail not to be shared. It should be noted that, if a shared group other than the “no designation” is chosen, the process described in FIG. 12 in the above will be executed.

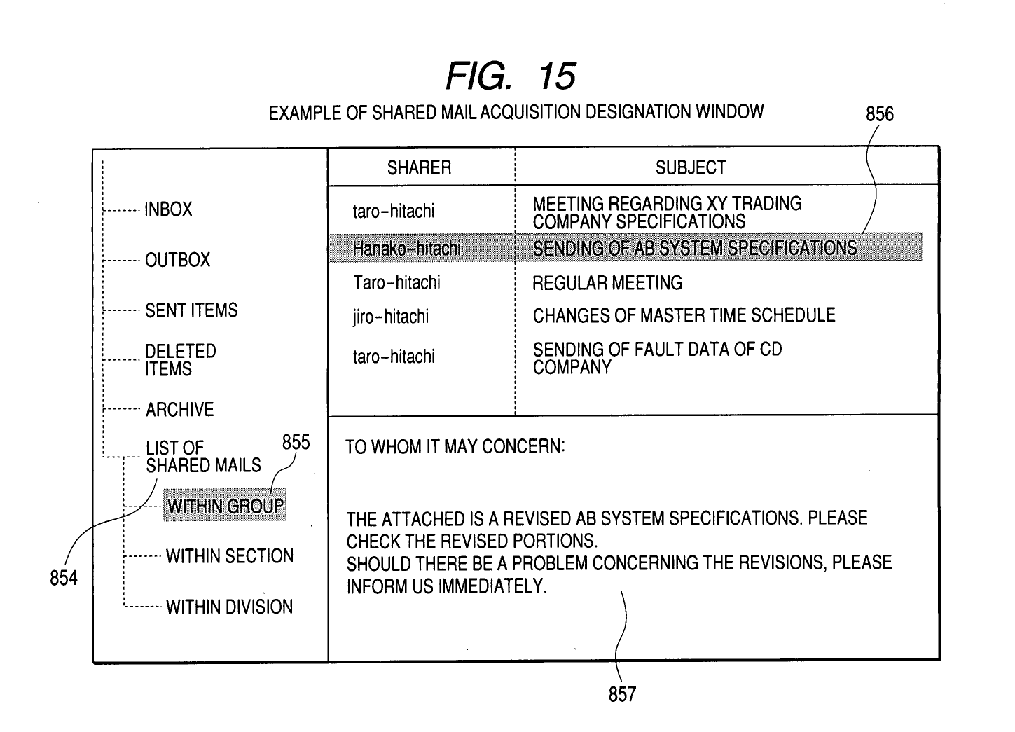

FIG. 15 is an example of a window to acquire a mail that is designated to be shared wherein the embodiment is applied. When the item “List of shared mails” 854 located at the lower left of the window is chosen, a list of shared mails is further displayed, and a list of mails which are currently shared by each terminal device is displayed according to lists of groups. Here, a list of mails that are designated to be shared when the “within group” 855 is selected is displayed. When a mail 856 to be referred to is chosen, the process described in FIG. 13 stated above will be executed, and the acquired mail is displayed in the pane 857 located at the lower right of the window.

With such configuration as stated above, the second embodiment can be implemented. Moreover, the table of shared mail links 162 on the server 3 is kept updated in the latest status, and shared mails can be seen at a terminal device only through communication with the server, thus enabling to lower the communication frequency.

Here, it should be noted that the communication paths 2 and 5 may be configured with wired, wireless or any other means.

It will be needless to say that the terminal devices according to the present invention should be in the scope of the present invention so far as such devices have a function to send and receive a mail. For example, such information terminal devices as a cell phone and a personal digital assistant (PDA) are included.

It should be noted that, with the embodiment, although link information of shared mails is requested to each terminal device registered with the group management table 134 with the timing when the off-line status is shifted to the on-line status, means for acquiring link information is not limited to the above. For example, it may be arranged that, with the timing of shifting from the off-line status to the on-line status, link information may be transmitted from the own terminal device to another terminal device. In this case, since the own terminal device grasps another terminal device which is transmitting link information, it is possible to prevent useless communication traffics.

In addition, another terminal device may grasp the status of respective terminal devices by transmitting information as to whether the status is off-line or on-line to another terminal device so that the another terminal device which received the information stores the status in the group management table. Since each terminal device can grasp the on-line and the off-line status of respective terminal devices, it is possible to prevent unnecessary communication.

It should be noted that, to enable another terminal device to receive an e-mail designated to be shared, even when a terminal device which records the e-mail designated to be shared tries to establish the off-line status, the portion required for transmitting the e-mail designated to be shared may be kept in the on-line status. In this case, another terminal device can always access to the shared mail.

With the first embodiment, there are only two options whether or not an e-mail is shared as shown in FIG. 7. However, it may be arranged to enable selection of parties with which e-mails are shared among a plurality of groups as shown in FIG. 14 by storing a plurality of groups in the group management table 134. In this case, a group with which e-mails are shared can be changed for each e-mail.

In addition, by uploading software in a terminal device, or in both a terminal device and a server, it is possible to obtain advantages of the first embodiment or the second embodiment. In this case, since it is not necessary to purchase an additional terminal device, etc., reduction in cost is expected.

It should be noted that, in the prior art, since data of a plurality of e-mails constituted one single file data, it was not possible to designate sharing of an arbitrary mail. However, with the above embodiment, it is possible to designate each mail to be shared.

With the embodiments stated above, each independent mail that is downloaded to a storage device of a terminal device is designated to be a shared mail, terminal devices share link information that is designated for sharing by their own terminals, and, when a desired mail is requested, the desired mail is acquired from a storage device of the target terminal device based on the link information. This permits mail sharing. With such arrangement, it becomes not necessary for a server to have mail data for sharing the mail, and it is possible to reduce capacity loads of a storage device of the server.

In addition, since an e-mail is exchanged among terminal devices, the number of accesses to a server can be reduced, thus reducing processing load of the server either.

1. An electronic mail system, wherein an electronic mail is sent and received between a first terminal device and a second terminal device, said electronic mail system comprising:
means for transmitting link information about a shared mail which is an e-mail designated to be shared among e-mails stored in said first terminal device to said second terminal device; and
means for allowing said first terminal device to transmit said shared mail to said second terminal device, when transmission of said shared mail is requested from said second terminal device by using said link information.

2. A terminal device which is applicable to an electronic mail system that sends and receives an e-mail with another first terminal device, said terminal device comprising:
a mail database which stores an e-mail;
a shared mail designation unit which designates an e-mail out of e-mails stored in said mail database to be shared with said another first terminal device;
a table of shared mail links which stores link information about a shared mail which is an e-mail that is designated to be shared by said shared mail designation unit; and
a transmission unit which transmits link information stored in said table of shared mail links to said another first terminal device.

3. The terminal device according to claim 2, wherein,
when transmission of said shared mail is requested by said another first terminal device by using said link information, the shared mail stored in said mail database is transmitted to said another first terminal device.

4. The terminal device according to claim 2, wherein,
said terminal device executes sending and receiving of an e-mail also to and from another second terminal device which is different from said another first terminal device,
said shared mail designation unit can designate sharing of an e-mail out of e-mails stored in said mail database with said another second terminal device, and
said transmission unit transmits, to said another second terminal device, link information about a second shared mail which is an e-mail that is designated to be shared with said another second terminal device by said shared mail designation unit.

5. The terminal device according to claim 2, wherein,
when transmission of said second shared mail is requested by said another second terminal device by using said link information, said second shared mail stored in said mail database is transmitted to said another second terminal device.

6. The terminal device according to claim 2, further comprising a group management table which is used to grasp whether said another first terminal device is in the on-line status or the off-line status.

7. Software which instructs a terminal device comprising a first storage unit, a second storage unit, a selection unit and a communication unit to execute procedures for:
storing an e-mail by said first storage unit;
selecting a shared mail out of said stored e-mails by said selection unit;
storing link information about said shared mail by said second storage unit;
transmitting said stored link information to another terminal device by said communication unit; and
when transmission of a shared mail by using said link information from said another terminal device is requested, transmitting said shared mail by said communication unit.
